(19) United States
(12) Patent Application Publication
(10) Pub. No.: US 2014/0222473 A1
(43) Pub. Date: Aug. 7, 2014

(54) METHOD AND SYSTEM OF DIRECT BIDDING FOR A TRAVEL-RELATED SERVICE VIA AN INTERNET-BASED TRAVEL SYSTEM

(71) Applicants: Pareshkumar Patel, Alemeda, CA (US); Abtin Rostamian, Pasadena, CA (US)

(72) Inventors: Pareshkumar Patel, Alemeda, CA (US); Abtin Rostamian, Pasadena, CA (US)

(21) Appl. No.: 13/757,541

(22) Filed: Feb. 1, 2013

(51) Int. Cl. G06Q 10/02

(52) U.S. Cl. CPC G06Q 10/02
USPC 705/5

(57) ABSTRACT

In one exemplary embodiment, a customer's search criteria with respect to a travel-related service is received. A database of a travel-service provider and a travel-related service is searched. A travel-related query result relevant to the customer's search criteria is received. The travel-related query result includes a pricing data for the travel-related service. The at least one travel-related query result to a customer's computing device is provided. A customer's bid for the travel-related service is received. The customer's computing device is provided an alternative travel-related service. A success probability value is calculated. The success probability value includes a probability that the customer's bid is accepted by the travel service provider. The alternative travel-related service is provided to the customer's computing device when the probability that the customer's bid is accepted by the travel service provider is below a specified threshold and the travel service provider does not accept the customer's bid.

### CROSS-REFERENCE TO RELATED APPLICATIONS

This application is a claims priority to U.S. patent provisional application No. 61/593,322 titled METHOD AND SYSTEM OF DIRECT BIDDING FOR A TRAVEL-RELATED SERVICE VIA AN INTERNET-BASED TRAVEL SYSTEM and filed on Feb. 1, 2012. This provisional application is hereby incorporated by reference in its entirety.

### BACKGROUND

1. Field

This application relates generally to travel-related services, and more particularly to a system and method of direct bidding for a travel-related service via an Internet-based travel system.

2. Related Art

Internet-based travel websites can be used to book travel-related services such as airline tickets, hotel reservations, car rentals, cruises, vacation packages and various attractions via the World Wide Web. Internet-based travel websites may not themselves be direct suppliers of the travel-related services; instead, they may mediate the provision of travel-related services to their customers from contracting travel-service providers. For example, direct online travel agents (DOTA) can provide a web site wherein a customer can book travel-related services. A DOTA may provide these travel-related services based on volume bookings for a particular travel-service provider's (e.g. a hotelier's, an airline's, etc.). The travel-service provider can set aside a certain volume of its travel-related services for the DOTA to book and then the DOTA independently markets the travel-related services. The customer may be offered a price by the DOTA and must accept the price in order to book the travel-related service under the DOTA's terms. The customer deals with the DOTA and not the eventual travel-service provider. It is the DOTA that negotiates the prices with the travel-service provider and not the customer.

As another example of an Internet-based travel website is an excess inventory online travel agent (EIOTA). An EIOTA can provide travel-related services based on excess inventory of a travel-service provider. In this way, the travel-service provider can offer discounts for the travel-related services provided through the EIOTA in return for the opportunity to maximize capacity. Prior contractual obligations may prevent an EIOTA from disclosing certain details about the travel-related services prior to a customer booking An EIOTA can utilize a “Name-Your-Own-Price” system for customer bookings. A customer may specify a price and a travel-related service, and the EIOTA can then consider matching the combination. However, a customer may not know the name of the travel service provider and/or the schedule (with air tickets) until after they make a nonrefundable purchase. In addition, the customer may deal with the EIOTA under the EIOTA's terms of business and not the travel-service provider. Consequently, the customer may not be able to maximize the discount, as the EIOTA and DOTA do not negotiate with travel-service providers on an individual basis. Thus, a need exists for an Internet-based travel system that allows a customer to interact directly with one or more travel-service providers and offer bids for travel-related services. It is further noted that other additional benefits in some embodiments may include, inter alia, that a hotelier (and/or another type of supplier) may benefit by the ability to offload unused inventory at rates of their discretion, even at time just preceding a deadline or when some decisive action can be taken. Additionally, they system may remove need on the hotelier to pre-allocate inventory as with the systems of other types of online travel agencies.

### BRIEF SUMMARY OF THE INVENTION

A method an Internet-based travel service includes the step of receiving a customer's search criteria with respect to a travel-related service. A database of a travel-service provider and a travel-related service is searched. A travel-related query result relevant to the customer's search criteria is received. The travel-related query result includes a pricing data for the travel-related service. The at least one travel-related query result to a customer's computing device is provided. A customer's bid for the travel-related service is received. The customer's computing device is provided an alternative travel-related service. A success probability value is calculated. The success probability value includes a probability that the customer's bid is accepted by the travel service provider. The alternative travel-related service is provided to the customer's computing device when the probability that the customer's bid is accepted by the travel service provider is below a specified threshold and the travel service provider does not accept the customer's bid.

### BRIEF DESCRIPTION OF THE DRAWINGS

The present application can be best understood by reference to the following description taken in conjunction with the accompanying figures, in which like parts may be referred to by like numerals.

FIGS. 1 A-C depict an example process of an Internet-based travel service, according to some embodiments.

FIG. 2 illustrates a block diagram of a sample-computing environment that can be configured to implement one or more embodiments.

FIG. 3 depicts an exemplary computing system that can be configured to perform any of the processes described herein.

FIG. 4 illustrates an example system 400 for an Internet-based travel service, according to some embodiments.

FIGS. 5 A-C depict an example process 500 of an Internet-based supplier service, according to some embodiments.

The Figures described above are a representative set, and are not an exhaustive with respect to embodying the invention.

### DESCRIPTION

Disclosed are a system, method, and article of manufacture of an Internet-based travel system. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Process Overview

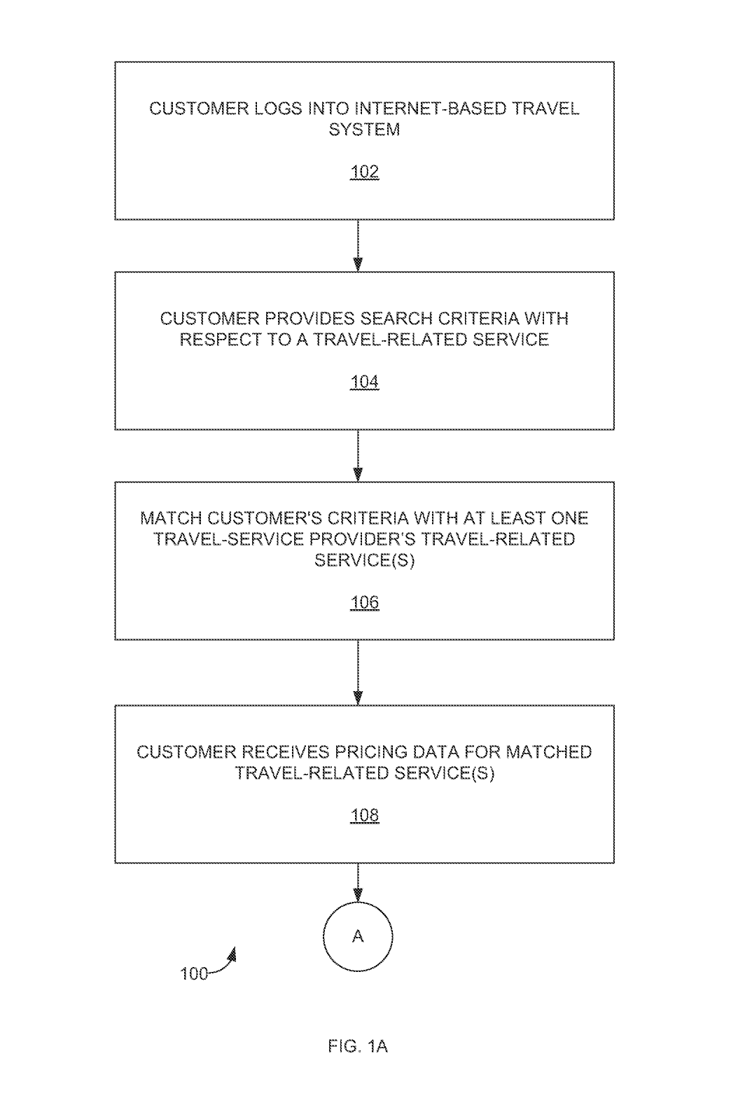

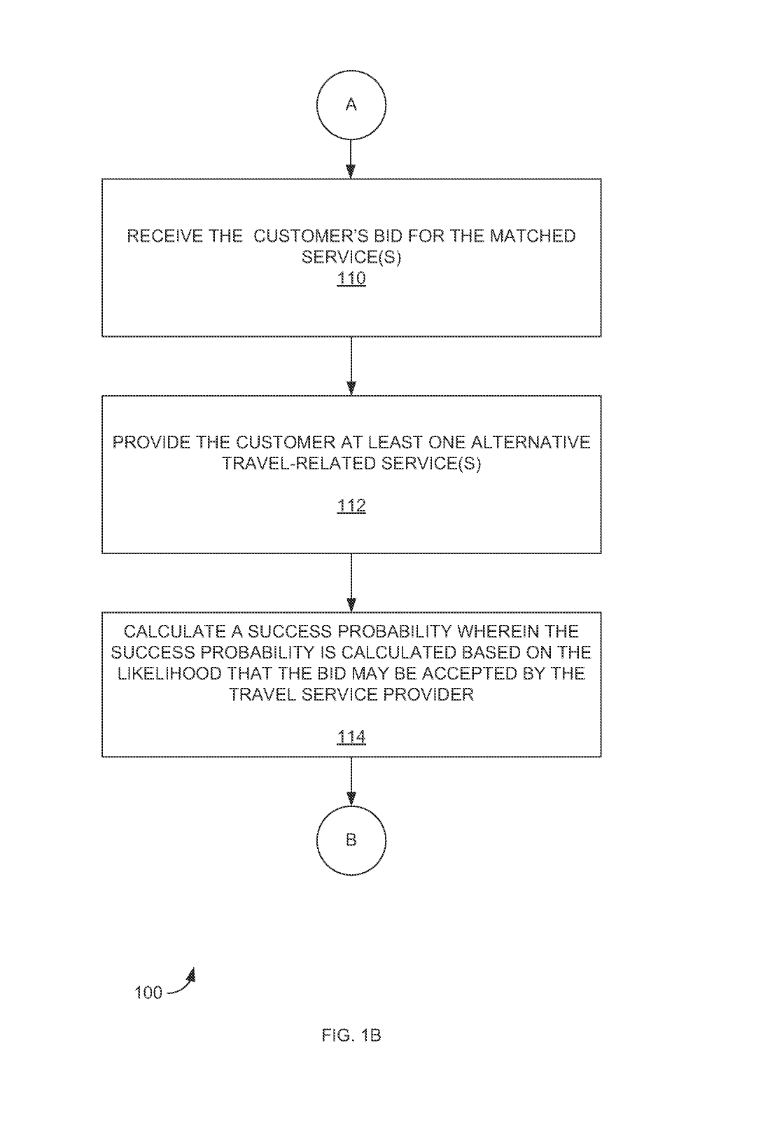

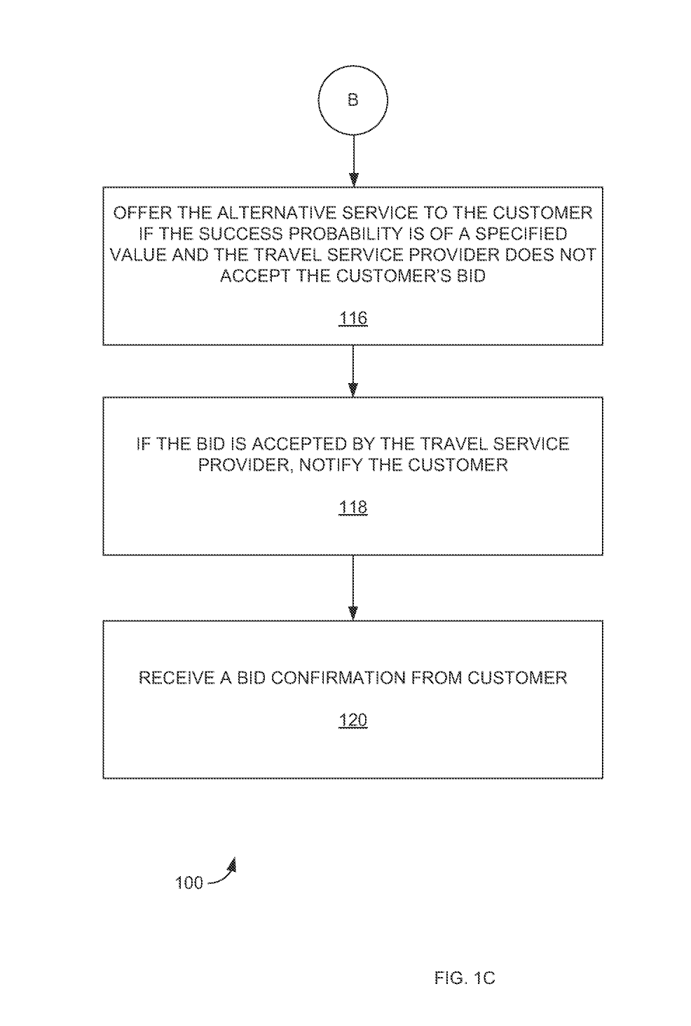

FIGS. 1 A-C depict an example process 100 of an Internet-based travel service, according to some embodiments. In step 102, a customer can log into an Internet-based travel system website. The website can be accessed with a web browser operating in any suitable device (e.g., mobile phone, tablet computer, personal computer, etc.). The website can require that a customer perform an authentication operation in order to be granted access to the customer's personal data such as account information, bid information, account history, communications from other system users, bid status and the like. The Internet-based travel system can provide information about travel related products and services to customers on behalf of travel-service providers such as airlines, car rentals, cruise lines, hotels, railways, sightseeing tours and/or package holidays and the like.

A customer can use a search engine maintained by the Internet-based travel system to search for various travel-related services. As used herein, travel-related services can include travel-related products and goods as well. It is further noted, that in other example embodiments, other types of services can be allocated that may not be within the travel genre such venue rentals and/or any other type of service and/or product discussed herein. The search engine can also be configured to enable the customer to include various criteria related to the travel-related service. Thus, in step 104, a customer can provide search criteria with respect to the travel-related service. The criteria can be relevant to the type of travel service the customer would like to locate. For example, if the customer is seeking hotel accommodations, the criteria can include hotel location, room parameters, hotel ratings, hotel amenities, booking dates, nearby entities (e.g. restaurants, tourist destinations, health services, sport events, etc.) and the like. The criteria can further include a time limit for which a customer's bid is available for response by a travel service provider (see infra).

In step 106, the customer criteria can be matched with at least one service provider's travel-related services. For example, the customer may have searched for the following criteria: a three star hotel suite in San Francisco near Union Square. The Internet-based travel system can then match these criteria with a list of corresponding hotels. Optionally, a level of tolerance for divergence from the indicated criteria can be included as a parameter of the customer's search query and/or results. The results can be provided to the customer (e.g. with a dashboard application on a web page and/or a smart phone application). It is noted that this step (as well as other steps of process 100) can be performed by one or more processes running on one or more servers operated by the Internet-based travel system.

In step 108, the customer is provided pricing data for the matched travel-related services. The pricing data can be based on the type of travel-related services and related criteria requested by the customer. For example, an average cost of a hotel room that meet the customer's criteria in a location and date can be the basis for the pricing data calculation (with adjustments to take into account other criteria specified by the customer such as star ratings, amenities, current events in the area, etc.). As another example, the pricing data can be an average of current market rates based on star ratings. The customer can utilize the pricing data as a guide to determine a bid (an amount the customer is willing to pay) for the matched travel-related services.

In step 110, the Internet-based travel system can receive the customer's bid for the matched travel-related services. This information can then be passed on to the pertinent travel service provider(s) such as hoteliers, restaurants, transportation services, recreational activity providers, travel insurance service, travel-related medical services and the like. For example, a travel service provider can also have an account with the Internet-based travel system. The service provider can log into the Internet-based travel system's website and access and/or modify information related to the services offered by the travel service provider (e.g. access and/or modify the information with a dashboard application). As an example, the service provider may be a hotelier. The hotelier can upload hotel information (e.g. room type, occupancy status, room costs, amenity information and the like) to the Internet-based travel system. This information can be utilized to match the hotel's services with customer search criteria. In addition, the Internet-based travel system can provide the hotelier with a dashboard application (e.g. a web page which collates information about a business) wherein the hotelier can view the status of available customer bids as well as communicate information related to the hotel and/or customer bids (e.g. accept a bid, input acceptance conditions, time-limits for customer actions, etc.) with customers.

In step 112, the Internet-based travel system can also provide the customer with at least one other alternative travel-related service and/or a discount thereto. The alternative travel-related service may be relevant to the customer's original search conditions. The alternative travel-related service may be available if the customer's bid(s) for the travel-related service is not accepted by any matched travel service provider. In some examples, the Internet-based travel system can enforce certain conditions that the customer must satisfy in order to qualify for the alternative travel-related service and/or to any discounts for the alternative travel-related service. For example, in step 114 the Internet-based travel system calculate a success probability based on the probability that the customer's bid to the originally matched and selected travel service provider will be accepted. If the success probability exceeds a specified threshold (e.g. an eighty percent chance of being accepted), the customer may be offered the alternative travel-related service offer in step 116 if the first travel service provider does not accept the customer's bid. A discount to the alternative travel-related service can also be varied as a function of the success probability.

If the first travel service provider does accept the bid, however, the Internet-based travel system can receive (and pass on to the customer) a notice of the acceptance, as shown in step 118. The notice may also include conditions for the customer to perform as specified by the travel service provider. For example, the travel service provider can impose a time limit by which the customer must confirm the bid. As another example, the travel service provider can request the customer perform an ancillary task such as post information about the travel service provider to the customer's social media networks. The Internet-based travel system can monitor and confirm with the travel service provider whether the customer has satisfied the conditions. It is noted that other travel service providers that also received the bid may also accept the bid subsequent to the first travel service provider. Thus, the customer may have a plurality of accepted bids as well as concomitant acceptance conditions. Finally, in step 120 a bid confirmation can be received from the customer. Thus, the customer has chosen to accept the bid as well as ancillary tasks stipulated by the travel service provider. A customer dashboard application can include elements for the customer to upload information pertaining to bid confirmation and ancillary task completion. In some embodiments, the Internet-based travel system can configure the website to enable the customer and the service-provider to negotiate additional terms regarding any ancillary customer tasks.

Steps may be added to or omitted (or rearranged into another order) from process 100 without straying from the scope of the embodiments. For example, in some embodiments, the alternative travel-related service of step 116 may be omitted in some example embodiments. Additionally, it is noted, that a customer may offer multiple bids for multiple services from a plurality of travel service provider s in multiple locations. Thus, the relationships between entities in the bidding system can have cardinalities of various types (many-to-many, many-to-one (rev. one-to-many), or one-to-one) according to some embodiments. It is also noted that in some example embodiments, the Internet-based travel system can include other types of computer networks such as cellular networks and/or private wide area networks. Thus, the Internet-based travel system need not be limited solely to Internet-based communications. Furthermore, a travel-related service can also include travel-related products, activities, amenities, etc. All data generated by process 100 can be stored in one or more databases administered by the Internet-based travel system.

### Exemplary Environment and Architecture

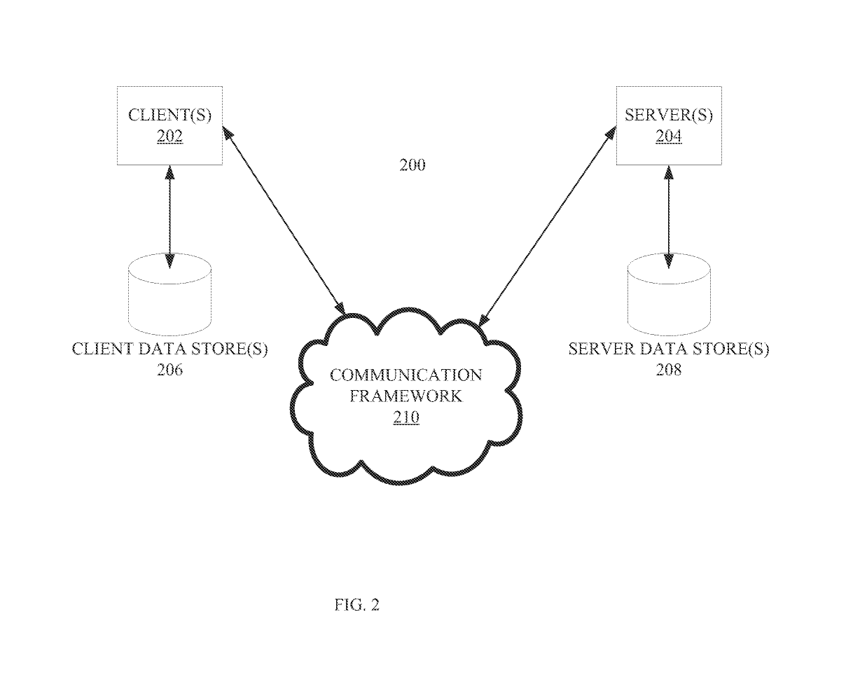

FIG. 2 illustrates a block diagram of a sample-computing environment 200 that can be configured to implement one or more embodiments. The system 200 further illustrates a system that includes one or more client(s) 202. The client(s) 202 can be hardware and/or software (e.g., threads, processes, computing devices). The system 200 also includes one or more server(s) 204. The server(s) 204 can also be hardware and/or software (e.g., threads, processes, computing devices). One possible communication between a client 202 and a server 204 may be in the form of a data packet adapted to be transmitted between two or more computer processes. The system 200 includes a communication framework 210 that can be employed to facilitate communications between the client(s) 202 and the server(s) 204. The client(s) 202 are connected to one or more client data store(s) 206 that can be employed to store information local to the client(s) 202. Similarly, the server(s) 204 are connected to one or more server data store(s) 208 that can be employed to store information local to the server(s) 204.

In some embodiments, system 200 can be include and/or be utilized by the various systems and/or methods described herein to implement process 100. For example, the specified content of step 102 can be stored in 206 and/or 208. User login verification can be performed by server 204. Moreover, server 204 can perform the Internet-based travel system operations of process 100.

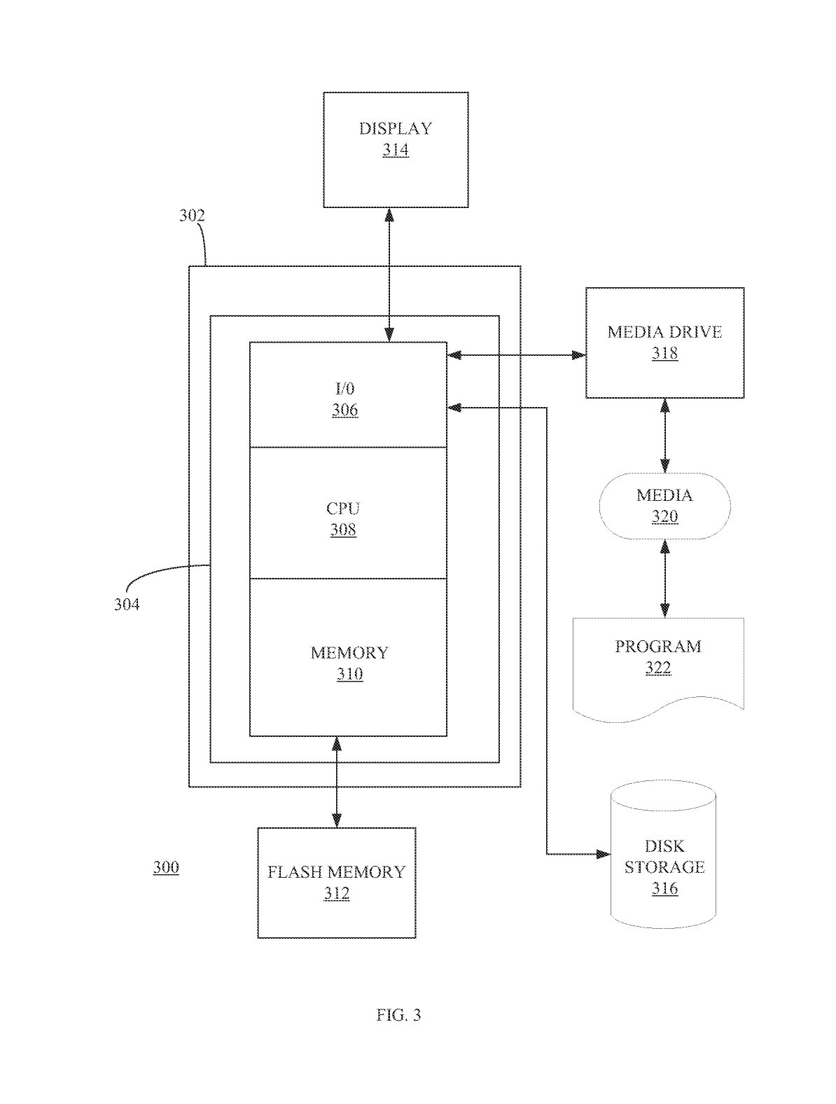

FIG. 3 depicts an exemplary computing system 300 that can be configured to perform any one of the above-described processes. In this context, computing system 300 may include, for example, a processor, memory, storage, and I/O devices (e.g., monitor, keyboard, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof

FIG. 3 depicts computing system 300 with a number of components that may be used to perform any of the processes described herein. The main system 302 includes a motherboard 304 having an I/O section 306, one or more central processing units (CPU) 308, and a memory section 310, which may have a flash memory card 312 related to it. The I/O section 306 can be connected to a display 314, a keyboard and/or other user input (not shown), a disk storage unit 316, and a media drive unit 318. The media drive unit 318 can read/write a computer-readable medium 320, which can contain programs 322 and/or data. Computing system 300 can include a web browser.

At least some values based on the results of the above-described processes can be saved for subsequent use. Additionally, a computer-readable medium can be used to store (e.g., tangibly embody) one or more computer programs for performing any one of the above-described processes by means of a computer. The computer program may be written, for example, in a general-purpose programming language (e.g., Pascal, C, C++, C#, Java) or some specialized application-specific language. Computing system 300 can be configured to perform the various steps and/or processes provided in the above description of FIGS. 1-2 and 4-5.

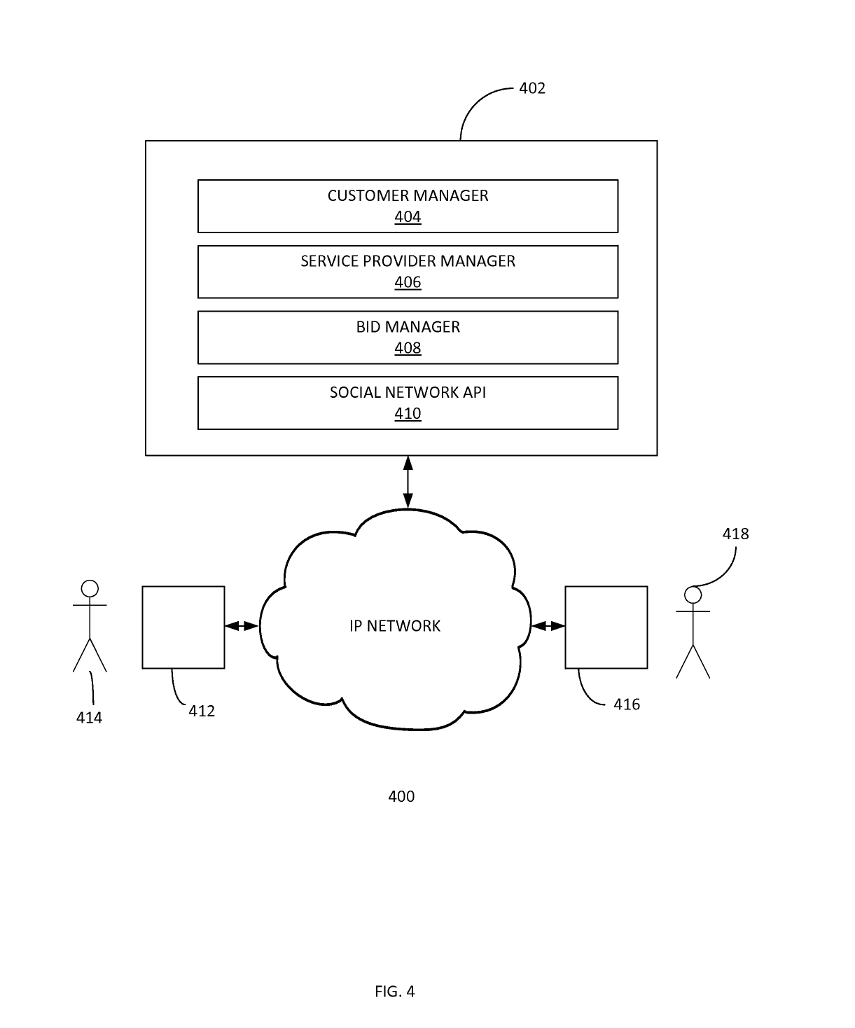

FIG. 4 illustrates an example system 400 for an Internet-based travel service, according to some embodiments. System 400 can include a server 402. Server 402 can communicate various entities such as travel-service application clients in user devices (e.g. such as 412 and 416), online social networks, databases, and the like. Server 402 can perform any of the various functionalities described herein in server-side environment. For example, server 402 can include a customer manager 404 module. Customer manager 404 module can maintain a database of customer profile information, customer bid requests, customer payments, etc. Customer manager 404 module can provide a dashboard view to a customer-side client application and receive customer input therefrom. Service manager 406 module can maintain a database of server provider profile information, server provider bid requests, server provider payments received, etc. Server provider manager 406 module can provide/manage a dashboard view to a server provider-side client application and receive server provider input therefrom. Bid manager 408 can manage customer bids and the current status of customer bids with respect to targeted travel service providers. Bid manager 408 can also manage verification of party obligations and manage payments vis-à-vis third parties (e.g. Paypal®, banks, etc.). Social network API 410 can

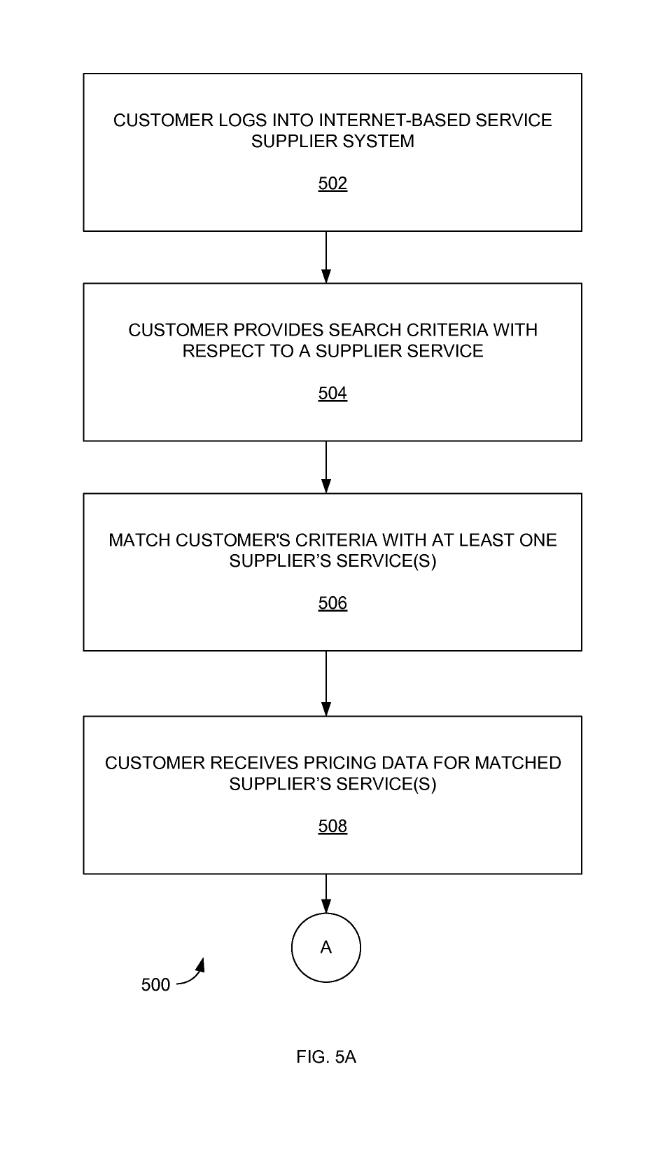

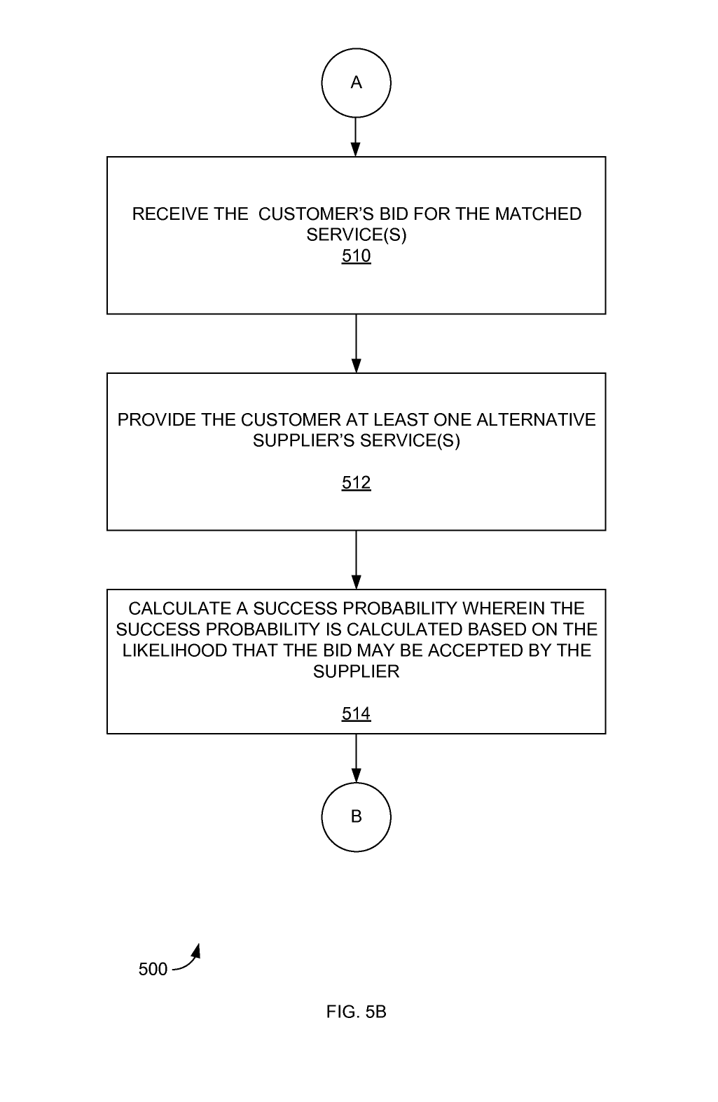

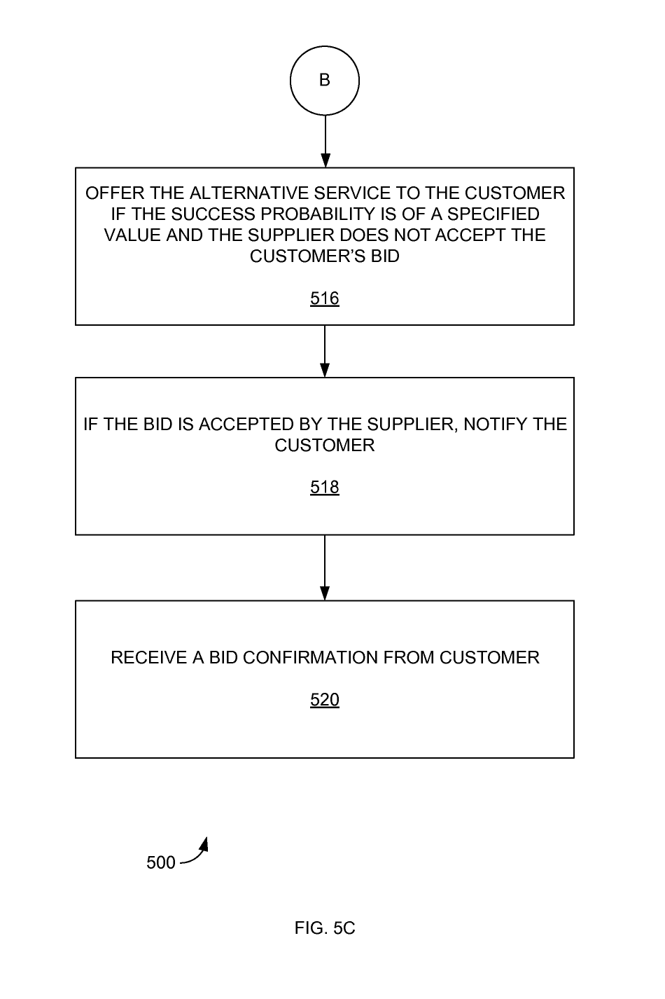

FIGS. 5 A-C depict an example process 500 of an Internet-based supplier service, according to some embodiments. In step 502 of process 500, a customer can log into an Internet-based service supplier system. A supplier service can include any supplier-type vertical market such as air travel, cruise vacations, car rentals, banquet hall rentals, yacht/boat rentals, conference halls, airplane rentals, conference halls, rail travel services, movie and other theater shows, professional services, sales of goods (e.g. goods available via an online retailer), any bookable, leasable, purchasable inventory and the like. In step 505, the customer can provide search criteria with respect to the supplier service. In step 506, the customer's criteria can be matched with at least one supplier's service. In step 508, the customer can receive pricing data for any matched supplier service(s). In step 510, the customer's bid is received for the matched services. In step 512, the customer can be provided with at least one alternative supplier's service. In step 514, a success probability can be calculated according to a variety of parameters. For example, the success probability can be calculated based on the likelihood that the bid may be accepted by the supplier. In step 516, an alternative service can be offered to the customer if the success probability is of a specified value and the supplier does not accept the customer bid. In step 518, if the bid is accepted by the supplier, the customer is notified. In step 520, the customer can then provide a bid confirmation. It is noted that a customer can bid on multiple services and that more than one supplier can accept a customer's bid. A customer can then choose among one or more accepted bids. It is noted that once a bid has been confirmed, the policies governing the transaction can then pass from the Internet-based supplier bid system to the supplier.

It is noted that process 500 can be utilized to perform the various embodiments of FIGS. 1-4. Process 500 can be performed by an Internet-based supplier bid system that is similar to the Internet-based travel system described supra.

According to some embodiments, a travel-service provider may be able to provide ratings of customers (e.g. a star rating) to the Internet-based travel system. These customer ratings may be made available to other travel-service providers. For example, the Internet-based travel system may maintain an account of each user (e.g. in a database table) that is available only to travel-service providers. Various parameters may be used to rate customers. For example, in the case where a travel-service provider is a hotelier, the customer can be rated on such parameters as how clean the customer left the room, whether there were noise complaints about the customer, how often did the customer use the hotel's facilities, did the customer spend extra for such amenities as room service, eat at the hotel's restaurant, and the like. The hoteliers can then utilize this information to provide a rating to the customer on a per stay basis. This rating can be aggregated with the ratings from other hoteliers (and/or various relevant travel-service providers) to generate an overall customer rating. In other embodiments, the Internet-based travel system may maintain may also maintain separate ratings on a travel service type. These ratings can be provided to the various travel-service providers via the travel-service provider's dashboard, for example.

According to some embodiments, the Internet-based travel system can also be configured to allow a travel-service provider to offer upgrades (e.g. extra amenities, coupons for hotel restaurants, upgrade in room rating, etc.) after the user/customer has made a final acceptance and the travel service is booked.

According to some embodiments, a customer may indicate a period of dates for which the customer is available rather than a specific date. The customer may still be able to set parameters with the indicated period such as a length of stay. For example, in the case of a hotel reservation, the customer may indicate that he is available to book a room for three days in the month of February to a set of hoteliers. Thus, the hoteliers can have greater flexibility in choosing what days to offer the customer in order to maximize a possible discount to the customer. This example is not limited to hoteliers. In another example, a customer can offer a bid to a set of airlines for a certain travel route that can be performed in an indicated period. For example, a customer can indicate that he wants to fly to New York for a week stay and then return in a three-month window.

It is noted that in one example embodiment, the word ‘bid’ may be understood to have a meaning other than the definition which is most often used in auction type businesses where it understood to be the price someone puts on a specific product or service that someone else has put up for auction. This price, depending on the auction style, may go up or down and the person putting a bid can place subsequent bids on the same item, again either up or down, while in competition with other bidders on the same item. However, in one example embodiment, the term ‘bid’ can include another type of process. For example, in one or more systems described herein, a ‘bid’ may act like a demand/supply facilitator. For example, a consumer can create a ‘bid’ for something desired and what is desired may or may not exist given the criteria and the price that the consumer depicted. Accordingly, the bid can provided to possible providers/suppliers and if said providers/suppliers are able to fulfill the consumers bid (both in terms of price and criteria), then the transaction may continue as the providers/suppliers accept the bid. Thus, the ‘bid’ may be an opportunity for one or more providers to supply some demand originating with a consumer. In the application of bookable inventory such as a hotel, a consumer can create a bid for a set of hotel-related criteria such as star rating, travel date, amenities, names of hotels, etc. that can be matched with any possible willing hotel. The system can identify possible suppliers of hotel rooms that may meet that criteria make the bid information available to the suppliers, and the suppliers can determine whether or not they are able and willing to fulfill the bid/demand created by the consumer. If so, the customer can then be notified of the provider and can choose to complete the transaction or wait for other suppliers to respond with further options.

It is further noted that in some embodiments, a provider/supplier may pre-accept bids by identifying certain criteria that they will automatically accept. According, if a consumer's bid criteria match the pre-accepted criteria, the transaction can occur in near real-time (assuming system latency and the like).

It is further noted that in some embodiments, that a providers/suppliers may be enabled to induce the customer to purchase more expensive items, upgrades, or other add-ons after the consumer has approved of an accepted bid and the initial transaction is completed. In other words, a provider may expose the consumer to additional options (e.g. a class upgrade and/or physical addons) that were perhaps not considered previously. For example, a consumer may book a standard room from a hotelier using one or more systems described above. The hotelier may then offer the consumer an upgrade to a suite (or other amenities such as champagne, restaurant vouchers and the like) for an additional fee. The embodiments are not limited in this context. For example, other bookable services can also allow a provider to upsell a consumer.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations).

Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method an Internet-based travel service comprising:
receiving a customer's search criteria with respect to a travel-related service;
searching a database of a travel-service provider and a travel-related service;
retrieving a travel-related query result relevant to the customer's search criteria, wherein the travel-related query result comprises a pricing data for the travel-related service;
providing the at least one travel-related query result to a customer's computing device;
receiving a customer's bid for the travel-related service;
providing the customer's computing device an alternative travel-related service;
calculating a success probability value, wherein the success probability value comprises a probability that the customer's bid is accepted by the travel service provider; and
providing the alternative travel-related service to the customer's computing device when the probability that the customer's bid is accepted by the travel service provider is below a specified threshold and the travel service provider does not accept the customer's bid.

2. The method fo claim 1, further comprising:
notifying the customer's computing device when the customer's bid is accepted by the travel-service provider.

3. The method of claim 2 further comprising:
receiving a bid confirmation from the customer.

4. The method of claim 1, wherein the probability that the customer's bid is accepted by the travel-service provider is based on a difference between the customer's bid and the average market price of the travel-related service.

5. The method of claim 4, wherein the probability that the customer's bid is accepted by the travel-service provider is further based on an occurrence of a substantially current local event, a substantially current travel-season metric and an occupancy data of hotels within a specified distance of the travel-related service.

6. The method of claim 1, wherein the travel-service provider comprises a hotelier.

7. The method of claim 1, wherein the travel-related service comprises a hotel stay.

8. The method of claim 1, wherein the travel-service provider places a condition on acceptance of the customer's bid.

9. The method of claim 8, wherein the condition comprises a requirement for the customer to post an advertisement about the travel-service provider on an online social-networking service administered by the customer.

10. The method of claim 9, wherein the travel-service provider offers an additional amenity to the customer based on the customer posting the advertisement about the travel-service provider on the online social-networking service administered by the customer.

11. The method of claim 10, further comprising:
providing a travel-service provider dashboard to the travel-service provider to manage a travel-related service and the requirement for the customer to post the advertisement about the travel-service provider on the online social-networking service administered by the customer.

12. An server for managing an Internet-based travel service in a computing environment comprising:
a processor configured to execute instructions;
a memory containing instructions when executed on the processor, causes the processor to perform operations that:
receiving a customer's search criteria with respect to a travel-related service;
searching a database of a travel-service provider and a travel-related service;
retrieving a travel-related query result relevant to the customer's search criteria, wherein the travel-related query result comprises a pricing data for the travel-related service;
providing the at least one travel-related query result to a customer's computing device;
receiving a customer's bid for the travel-related service;
providing the customer's computing device an alternative travel-related service;
calculating a success probability value, wherein the success probability value comprises a probability that the customer's bid is accepted by the travel service provider; and
providing the alternative travel-related service to the customer's computing device when the probability that the customer's bid is accepted by the travel service provider is below a specified threshold and the travel service provider does not accept the customer's bid.

13. The method fo claim 12, further comprising:
notifying the customer's computing device when the customer's bid is accepted by the travel-service provider.

14. The method of claim 13 further comprising:
receiving a bid confirmation from the customer.

15. The method of claim 12, wherein the probability that the customer's bid is accepted by the travel-service provider is based on a difference between the customer's bid and the average market price of the travel-related service.

16. The method of claim 15, wherein the probability that the customer's bid is accepted by the travel-service provider is further based on an occurrence of a substantially current local event, a substantially current travel-season metric and an occupancy data of hotels within a specified distance of the travel-related service.

17. The method of claim 12, wherein the travel-service provider comprises a hotelier.

18. The method of claim 12, wherein the travel-service provider places a condition on acceptance of the customer's bid.

19. The method of claim 18, wherein the condition comprises a requirement for the customer to post an advertisement about the travel-service provider on an online social-networking service administered by the customer.

20. The method of claim 19,
wherein the travel-service provider offers an additional amenity to the customer based on the customer posting the advertisement about the travel-service provider on the online social-networking service administered by the customer.
